(19) United States
(12) Patent Application Publication
(10) Pub. No.: US 2013/0169039 A1
(43) Pub. Date: Jul. 4, 2013

(54) HIGH-VOLTAGE BATTERY CONVERTER

(71) Applicants: Charles Zhu, Canton, MI (US); Chao Yan, Shanghai (CN); Lingjie Meng, Shanghai (CN); Sheng Hui Pai, Taoyuan Hsien (TW)

(72) Inventors: Charles Zhu, Canton, MI (US); Chao Yan, Shanghai (CN); Lingjie Meng, Shanghai (CN); Sheng Hui Pai, Taoyuan Hsien (TW)

(73) Assignees: DELTA ELECTRONICS, INC., Taoyuan Hsien (CN); DELTA ELECTRONICS (SHANGHAI) CO., LTD, Shanghai (CN)

(21) Appl. No.: 13/605,541

(22) Filed: Sep. 6, 2012

(30) Foreign Application Priority Data
Jan. 4, 2012 (CN) 201210001078.6

(51) Int. Cl. B60L 1/00

(52) U.S. Cl. 307/10.1

(57) ABSTRACT

Disclosed is a high-voltage battery converter including a first-order DC-DC converter electrically connected to a high-voltage battery for boosting a high DC voltage outputted by the high-voltage battery to an intermediate voltage having a predetermined voltage level when the high DC voltage is dropped, and a second-order DC-DC converter electrically connected to the first-order DC-DC converter for converting the intermediate voltage into a low DC voltage for driving at least one load in an electric vehicle.

### FIELD OF THE INVENTION

The invention is related to a high-voltage battery converter, and more particularly to a high-voltage battery converter applied to the electric vehicle.

### BACKGROUND OF THE INVENTION

The advent of the internal combustion vehicle has improved the mobility for the human kind and helped the delivery of merchandise. With the improvements in the auto-making technology, the internal combustion vehicles have been massively produced. Nowadays, the amount of the internal combustion vehicle in the world is around 850 million. Also, nearly 57% of the fuel consumption is expended in the traffic domain (where the United States accounts for 67% of the fuel consumption expended in the traffic domain). It is estimated that the amount of the internal combustion vehicle will reach 1.2 billion in 2020. Hence, a net deficit will be occurred between the global fuel demand and the regular fuel supply. The unbalance between petroleum supply and demand will be increasingly worsened. It is estimated that the deficit between the petroleum supply and demand in 2050 will be double to the total petroleum production in 2000. Thus, the oil price will hike up dramatically and the cost paid by the automakers will be prohibitive. Therefore, the automakers endeavor to make vehicles using renewable energy source in order to change the energy usage characteristics and lessen the demand of petroleum.

Also, when the internal combustion vehicle is running, the petroleum is combusted. This would cause air pollution and endanger the ecology. In recent years, the automakers strive to make electric vehicles as the green vehicle of the next generation. As the manufacturing technique of the electric vehicle has been matured and the power grid has been widely installed all over the world, the electric vehicle (EV) or the plug-in hybrid electric vehicle (PHEV) is expected to completely replace the internal combustion vehicle in the near future.

The electric vehicle and the plug-in hybrid electric vehicle both use a high-voltage battery as a reliable power source. The high-voltage battery of the electric vehicle can be charged by means of a charging station through a charging system in the electric vehicle. Thus, the high-voltage battery provides the electric energy for propelling the electric vehicle. Also, in order to let the high-voltage energy outputted by the high-voltage battery to be used by the electronic devices in the electric vehicle that is driven by a low voltage (e.g. a low-voltage battery), a high-voltage battery converter is required to be mounted in the electric vehicle to convert the high-voltage energy of the high-voltage battery into low-voltage energy.

Referring to FIG. 1, which shows the circuitry of a conventional high-voltage battery converter. As shown in FIG. 1, the conventional high-voltage battery converter 1 is applied to an electric vehicle and connected between a high-voltage battery 90 and a load 91 that is driven by a low voltage. The high-voltage battery converter 1 is used to convert the high DC voltage V_{H} outputted by the high-voltage battery 90 into a low DC voltage V_{L} for driving the load 91 to operate. The high-voltage battery converter 1 includes an electromagnetic interference filter (EMI filter) 10 and a DC-DC converter 11. The electromagnetic interference filter 10 is connected to the high-voltage battery 90 for suppressing the electromagnetic interference. The DC-DC converter 11 is connected to the electromagnetic interference filter (EMI filter) 10 and the load 91 for converting the high DC voltage V_{H} outputted by the high-voltage battery 90 into a low DC voltage V_{L} for driving the load 91.

Though the conventional high-voltage battery converter 1 can convert the high DC voltage V_{H} outputted by the high-voltage battery 90 into a low DC voltage V_{L} for driving the load 91 to operate, the high-voltage battery 90 can not be charged when the electric vehicle is running and the load 91 is operating. Hence, the high-voltage battery 90 will output electric energy continuously, which in turn lowers the voltage level of the high DC voltage V_{H}. In this manner, the output current Iₒ of the high-voltage battery 90 will increase along with the decrease of the high DC voltage V_{H}. Therefore, the electronic elements in the DC-DC converter 11, such as the switch elements and rectifiers, will suffer a large current and an increasing temperature. This would damage the electronic elements in the DC-DC converter 11 due to the high temperature and high current. Under this condition, the DC-DC converter 11 will have a considerable power loss and poor conversion efficiency.

To address the aforementioned problem, the electronic elements in the DC-DC converter 11 has to be implemented by materials with high ratings, in order to suffer a large current and avoid the temperature of the electronic elements from increasing. Or otherwise, a specific circuit structure has to be employed to model the relationship of the output power of the DC-DC converter 11 versus the high DC voltage of the high-voltage battery as that shown in FIG. 2. In this case, when the high DC voltage V_{H} is relatively high (e.g. the power P₁ shown in FIG. 2), the output power of the DC-DC converter 11 should also be relatively high (e.g. the power P₁ shown in FIG. 2). Otherwise, when the voltage of the high-voltage battery 90 is decreased, the output power of the DC-DC converter 11 should also be adjusted to a low level (e.g. the power P₂ shown in FIG. 2). Thus, the output current Iₒ of the high-voltage battery 90 will not increase due to the decrease of the voltage of the high-voltage battery 90. Nonetheless, these solutions will increase the cost of the high-voltage battery converter 1, or lose the driving capability to some electronic elements that required to be driven by high power.

It is a tendency to develop a high-voltage battery converter to counteract the problems encountered by the prior art.

### The SUMMARY OF THE INVENTION

An object of the invention is to provide a high-voltage battery converter for addressing the problem encountered by the prior art that the output current of the high-voltage battery is increasingly elevated while the high DC voltage of the high-voltage battery is dropped. Using the invention, the electronic elements in the DC-DC converter are protected from damage, and the conversion efficiency of the DC-DC converter is boosted. Furthermore, the cost of the high-voltage battery converter is lowered with the rated power of the high-voltage battery converter remained intact.

To this end, the invention provides a high-voltage battery converter including a first-order DC-DC converter electrically connected to a high-voltage battery for boosting a high DC voltage outputted by the high-voltage battery to an intermediate voltage having a predetermined voltage level when the high DC voltage is dropped, and a second-order DC-DC converter electrically connected to the first-order DC-DC converter for converting the intermediate voltage into a low DC voltage for driving at least one load in an electric vehicle.

Now the foregoing and other features and advantages of the invention will be best understood through the following descriptions with reference to the accompanying drawings, in which:

### BRIEF DESCRIPTION OF THE DRAWINGS

FIG. 1 shows the circuitry of a conventional high-voltage battery converter;

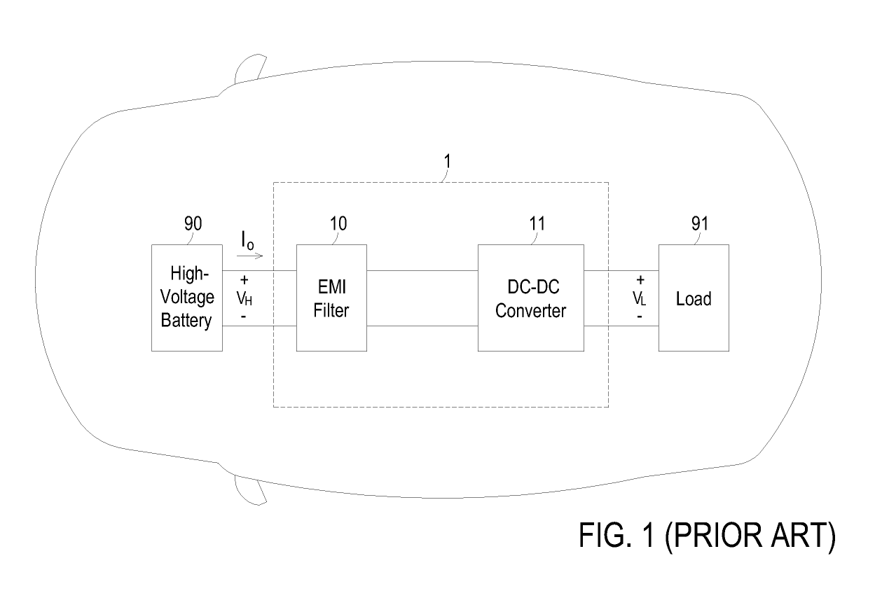

FIG. 2 is a curve diagram showing the relationship of the output power of the DC-DC converter versus the high DC voltage of the high-voltage battery according to the prior art;

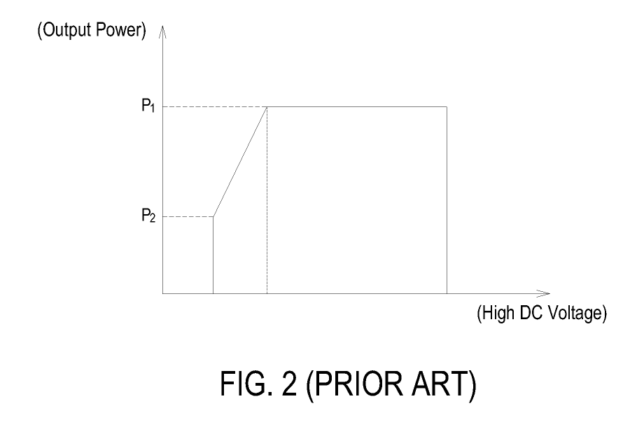

FIG. 3 shows the circuitry of a high-voltage battery converter according to an exemplary embodiment of the invention;

FIG. 4 is a curve diagram showing the relationship of the conversion efficiency of the second-order DC-DC converter versus the load; and

FIG. 5 is a curve diagram showing the relationship of the switching loss of the switch circuit of the second-order DC-DC converter versus the load.

### DESCRIPTION OF THE PREFERRED EMBODIMENT

An exemplary embodiment embodying the features and advantages of the invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as a confinement for the invention.

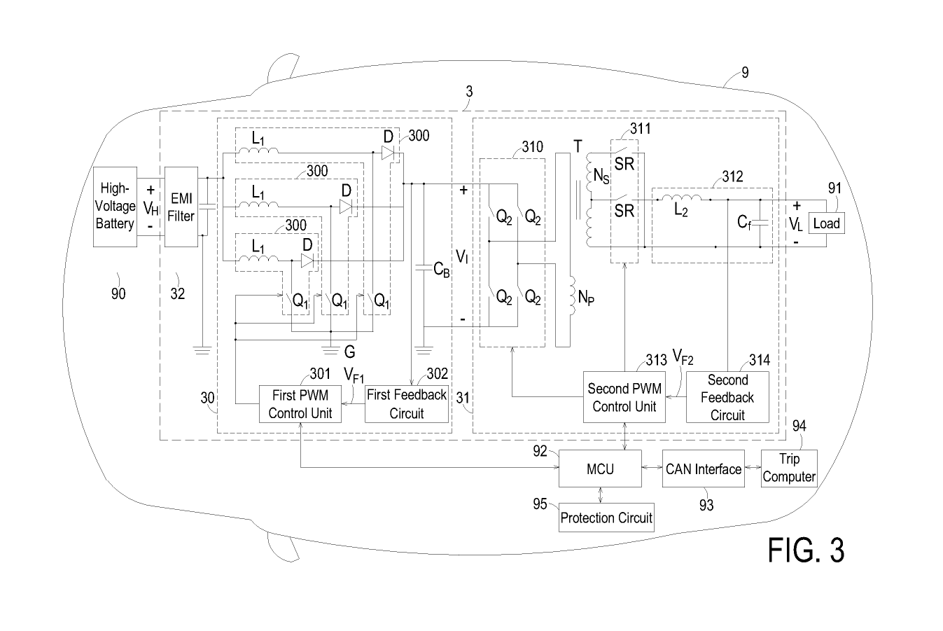

Referring to FIG. 3, which shows the circuitry of a high-voltage battery converter according to an exemplary embodiment of the invention. As shown in FIG. 3, the high-voltage battery converter 3 may be applied to an electric vehicle and mounted in the body 9 of an electric vehicle. The high-voltage battery converter 3 is electrically connected to a high-voltage battery 90 and at least one load 91. The load 91 may be driven by a low voltage of 10-16V, and may be implemented by a low-voltage battery, a stereo, or a headlight of an automobile.

The high-voltage battery converter 3 includes a first-order DC-DC converter 30 and a second-order DC-DC converter 31. The first-order DC-DC converter 30 is electrically connected between the high-voltage battery 90 and the second-order DC-DC converter 31. When the electric vehicle is driving and the high-voltage battery 90 is releasing electric energy continuously, the level of the high DC voltage V_{H} outputted by the high-voltage battery 90 will drop. When the level of the high DC voltage V_{H} outputted by the high-voltage battery 90 has dropped down to be below a predetermined voltage level, the first-order DC-DC converter 30 will boost the high DC voltage V_{H} up to an intermediate voltage V₁ having the predetermined voltage level.

In this embodiment, as shown in FIG. 3, the high-voltage battery converter 3 further includes an electromagnetic interference filter (EMI filter) 32 connected between the high-voltage battery 90 and the first-order DC-DC converter 30. The electromagnetic interference filter 32 is used to filter out the electromagnetic interference at the input end of the first-order DC-DC converter 30.

In this embodiment, the first-order DC-DC converter 30 may include a DC-DC boost converter, which includes at least one boost circuit 300 and a bus capacitor C_{B}. As shown in FIG. 3, a pair of boost circuits 300 are used, in which each boost circuit 300 is connected in parallel with each other and each boost circuit 300 includes a boost choke L₁, a diode D, and a first switch element Q₁. The boost choke L₁ is connected between the high-voltage battery 90 and the anode of the diode D. One end of the first switch element Q₁ is connected to the boost choke L₁ and the anode of the diode D, and the other end of the switch element Q₁ is connected to a ground terminal G. The cathode of the diode D is connected to one end of the bus capacitor C_{B}. The other end of the bus capacitor C_{B} is connected to the ground terminal G. The bus capacitor C_{B} is used to store energy and stabilize the voltage. Hence, when the first switch element Q₁ is conducting its ON/OFF switching operation, the boost choke L₁ will charge and discharge accordingly. Under this condition, the high DC voltage V_{H} is boosted, thereby allowing the first-order DC-DC converter 30 to output the intermediate voltage V₁ by the rectification operation of the diode D and the stabilization operation of the bus capacitor C_{B}.

Certainly, the number of the boost circuit 300 may not be limited to two as shown in FIG. 3. Instead, the number of the boost circuit 300 may be only one or more than two depending on the cost or control method. As the first-order DC-DC converter 30 may employ a plurality of boost circuits 300 to boost the high DC voltage V_{H}, the duty cycle of the first switch element Q₁ of each boost circuit 300 may decrease. Thus, the efficiency of the boost circuit 300 is improved. Furthermore, the first switch element Q₁ may have a small current rating. More advantageously, the first switch element Q₁ may be used to suppress the voltage ripples and current ripples, so that the bus capacitor C_{B} can be downsized without the need of extra filter circuits.

In this embodiment, the first-order DC-DC converter 30 further includes a first pulse-width modulation control unit (first PWM control unit) 301 and a first feedback circuit 302. The first feedback circuit 302 is connected to the output end of the first-order DC-DC converter 30 for outputting a first feedback signal V_{F1} according to the magnitude of the intermediate voltage V₁. The first pulse-width modulation control unit 301 is connected to the control terminal of the first switch element Q₁ and the first feedback circuit 302 for regulating the duty cycle of the first switch element Q₁ according to the first feedback signal V_{F1}. In this manner, when the high DC voltage V_{H} of the high-voltage battery 90 is dropping, the first-order DC-DC converter 30 can boost the high DC voltage V_{H} up to the intermediate voltage V₁ having the predetermined voltage level.

In this embodiment, as shown in FIG. 3, the first pulse-width modulation control unit 301 can be connected to a micro-controller unit (MCU) 92 of the electric vehicle, thereby reporting the operating status of the first-order DC-DC converter 30 to the micro-controller unit (MCU) 92. In this manner, the micro-controller unit (MCU) 92 can report the information to the trip computer 94 of the electric vehicle through a controller area network (CAN) interface 93, thereby allowing the trip computer 94 to obtain the processed information from the micro-controller unit (MCU) 92. For example, when the first-order DC-DC converter 30 is undergoing an over-voltage condition or an over-current condition, the trip computer 94 can obtain the information that the micro-controller unit (MCU) 92 activates a protection circuit 95 of the electric vehicle to execute an over-voltage protection operation or an over-current protection operation through the controller area network (CAN) interface 93.

In this embodiment, the second-order DC-DC converter 31 is connected between the first-order DC-DC converter 30 and the load 91 for converting the intermediate voltage V₁ into a low DC voltage V_{L} and output the low DC voltage V_{L} to the load 91, thereby driving the load 91 to operate.

In this embodiment, the second-order DC-DC converter 31 may include a phase-shift full-bridge converter. Alternatively, the second-order DC-DC converter 31 may include a forward converter. The second-order DC-DC converter 31 includes a switch circuit 310, a transformer T, a rectifier 311, and a filter 312. The switch circuit 310 includes a plurality of second switch elements Q₂ that are configured as a full-bridge circuit. The switch circuit 310 is connected to the output end of the first-order DC-DC converter 30 and the primary winding Nₚ of the transformer T. The switch circuit 310 is configured to allow the electric energy of the intermediate voltage V₁ to the secondary winding Nₛ by its switching operations. The rectifier 311 is connected to the secondary winding Nₛ for rectifying the electric energy received by the secondary winding Nₛ. The filter 312 is connected between the rectifier 311 and the load 91 for filtering the rectified voltage outputted by the rectifier 311 to generate a low DC voltage V_{L} for use by the load 91.

In this embodiment, the second-order DC-DC converter 31 further includes a second pulse-width modulation control unit (second PWM control unit) 313 and a second feedback circuit 314. The second feedback circuit 314 is connected to the output end of the second-order DC-DC converter 31 for outputting a second feedback signal V_{F2} according to the magnitude of the low DC voltage V_{L}. The second pulse-width modulation control unit 313 is connected to the control terminal of the switch circuit 310 and the second feedback circuit 314 for regulating the duty cycle of the switch circuit 310 according to the second feedback signal V_{F2}. Thus, the low DC voltage V_{L} outputted by the second-order DC-DC converter 31 can be maintained at a rated level.

In this embodiment, as shown in FIG. 3, the second pulse-width modulation control unit 313 is also connected to the micro-controller unit (MCU) 92 for reporting the operating status of the second-order DC-DC converter 31 to the micro-controller unit (MCU) 92. In this manner, the micro-controller unit (MCU) 92 can report the information to the trip computer 94 of the electric vehicle through the controller area network (CAN) interface 93, thereby allowing the trip computer 94 to understand the current status of the second-order DC-DC converter 31 through the micro-controller unit (MCU) 92. For example, when the second-order DC-DC converter 31 is undergoing an over-voltage condition or an over-current condition, the trip computer 94 can understand that the micro-controller unit (MCU) 92 activates a protection circuit 95 of the electric vehicle to execute an over-voltage protection operation or an over-current protection operation for the second-order DC-DC converter 31.

In this embodiment, the secondary winding Nₛ of the transformer T may be a central-tapped winding. The rectifier 311 may include a plurality of synchronous rectifiers SR that are connected to the second pulse-width modulation control unit 313. The synchronous rectifiers SR are used to carry out synchronous rectification operation by the control of the second pulse-width modulation control unit 313. The filter 312 may include a filtering inductor L₂ and a filtering capacitor C_{f}. Also, when the electric vehicle is running, the high DC voltage V_{H} outputted by the high-voltage battery 90 is substantially fluctuating between 200V and 400V, and the intermediate voltage V₁ is substantially 320V. The low DC voltage V_{L} is substantially 10V-16V.

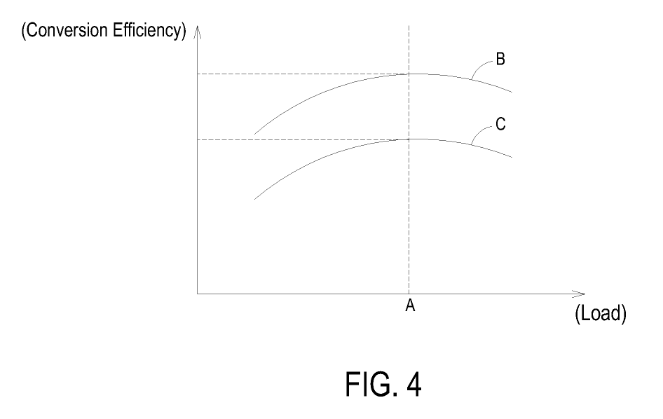

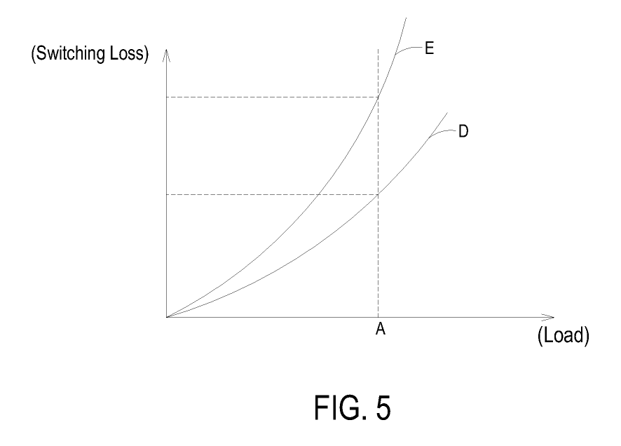

Referring to FIGS. 3, 4 and 5, in which FIG. 4 shows the relationship of the conversion efficiency of the second-order DC-DC converter versus the load and FIG. 5 shows the relationship of the switching loss of the switch circuit of the second-order DC-DC converter versus the load. It can be understood from FIGS. 3-5 that under the same load such as the load A indicated in FIGS. 4 and 5, the higher the voltage received by the second-order DC-DC converter 31 (as indicated by the curve B of FIG. 4 and the curve D of FIG. 5), the less the switching loss of the switch circuit 310 is and the better the conversion efficiency of the second-order DC-DC converter 31 is. On the contrary, the lower the voltage received by the second-order DC-DC converter 31 (as indicated by the curve C of FIG. 4 and the curve E of FIG. 5), the more the switching loss of the switch circuit 310 is and the worse the conversion efficiency of the second-order DC-DC converter 31 is. Because the high-voltage battery converter 3 includes a first-order DC-DC converter 30, as the high DC voltage V_{H} outputted by the high-voltage battery 90 is dropped during the running phase of the electric vehicle, the high DC voltage V_{H} can be boosted to the intermediate voltage V₁ having a high predetermined voltage level which is outputted to the second-order DC-DC converter 31. In this manner, as the electric vehicle is running, the second-order DC-DC converter 31 receives the intermediate voltage V₁ instead of receiving the dropping DC voltage V_{H}, so that the input current of the second-order DC-DC converter 31 will not be elevated as the high DC voltage V_{H} is dropped. Therefore, the electronic elements within the second-order DC-DC converter 31 do not have to suffer a large current, and the temperature of the electronic elements within the second-order DC-DC converter 31 do not elevate continuously. Hence, the electronic elements are more invulnerable and are allowed to be implemented with materials with lower power ratings and lower cost. Thus, the cost of the high-voltage battery converter 3 is reduced. More advantageously, the switching loss of the switch circuit 310 within the second-order DC-DC converter 31 is reduced, and the conversion efficiency of the second-order DC-DC converter 31 is improved. Furthermore, the second-order DC-DC converter 31 is able to output the same amount of power. Moreover, the as the input current of the second-order DC-DC converter 31 is lower, the number of the coils of the primary winding Nₚ can be reduced on the condition that the transformer T is unsaturated (e.g. the ambient temperature of the transformer T is below 70 degree Celsius). Also, the cross-section area of the magnetic core of the transformer T can be reduced, and the transformer T is downsized accordingly. Thus, the spatial utilization of the electric vehicle is enhanced.

In conclusion, the inventive high-voltage battery converter is featured by placing a first-order DC-DC converter between the high-voltage battery and the second-order DC-DC converter. Thus, when the electric vehicle is running and the high DC voltage of the high-voltage battery is dropping, the high DC voltage of the high-voltage battery is boosted up to an intermediate voltage having a high predetermined voltage level, which is in turn outputted to the second-order DC-DC converter. Hence, the input current received by the second-order DC-DC converter will not be elevated as the high DC voltage is dropped. In this way, the electronic elements of the second-order DC-DC converter can be invulnerable and can be implemented with materials with lower power ratings and lower cost. Hence, the cost of the high-voltage battery converter is lowered. Also, the output power of the second-order DC-DC converter can be maintained at the same level, while the conversion efficiency of the second-order DC-DC converter is enhanced. More advantageously, the spatial utilization of the electric vehicle is promoted.

While the invention has been described in terms of what are presently considered to be the most practical and preferred embodiments, it is to be understood that the invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the invention which is defined by the appended claims.

What is claimed is:

1. A high-voltage battery converter, comprising:
a first-order DC-DC converter electrically connected to a high-voltage battery for boosting a high voltage of the high-voltage battery to an intermediate voltage having a predetermined voltage level when the high-voltage battery is releasing electric energy and the high voltage of the high-voltage battery is dropped; and
a second-order DC-DC converter electrically connected to the first-order DC-DC converter for converting the intermediate voltage into a low DC voltage, thereby allowing an electric vehicle to drive at least one load in the electric vehicle.

2. The high-voltage battery converter according to claim 1 wherein the first-order DC-DC converter includes a DC-DC boost converter.

3. The high-voltage battery converter according to claim 1 wherein the second-order DC-DC converter includes a phase-shift full-bridge converter.

4. The high-voltage battery converter according to claim 1 wherein the first-order DC-DC converter includes:
at least one boost circuit, each of which includes a boost choke, a diode, and a switch element, wherein the boost choke is connected between the high-voltage battery and an anode of the diode, the switch element is connected among the boost choke, the anode of the diode, and a ground terminal; and
a bus capacitor connected to a cathode of the diode and the ground terminal, and connected to an input end of the second-order DC-DC converter.

5. The high-voltage battery converter according to claim 4 wherein the first-order DC-DC converter includes a plurality of boost circuits being connected in parallel with each other.

6. The high-voltage battery converter according to claim 4 wherein the first-order DC-DC converter further includes:
a first feedback circuit connected to an output end of the first-order DC-DC converter for outputting a first feedback signal according to the magnitude of the intermediate voltage; and
a first pulse-width modulation control unit connected to a control terminal of the switch element for controlling switching operations of the switch element by regulating a duty cycle of the switch element according to the first feedback signal, thereby maintaining the intermediate voltage at the predetermined voltage level.

7. The high-voltage battery converter according to claim 6 wherein the first pulse-width modulation control unit is connected to a micro-controller unit for reporting an operating status of the first-order DC-DC converter to the micro-controller unit, thereby allowing the micro-controller unit to send information of the operating status of the first-order DC-DC converter to a trip computer of the electric vehicle through a controller area network interface to facilitate the trip computer to obtain processed information from the micro-controller unit.

8. The high-voltage battery converter according to claim 7 wherein when the first-order DC-DC converter is undergoing an over-voltage condition or an over-current condition, a protection circuit of the electric vehicle is activated to carry out an over-voltage protection operation or an over-current protection operation, thereby allowing the micro-controller unit to report information that the first-order DC-DC converter is protected to the trip computer of the electric vehicle.

9. The high-voltage battery converter according to claim 1 wherein the second-order DC-DC converter includes:
a transformer having a primary winding and a secondary winding;
a switch circuit connected to an output end of the first-order DC-DC converter and the primary winding for driving the primary winding to transfer energy of the intermediate voltage to the secondary winding according to switching operations of the switch circuit;
a rectifier connected to the secondary winding for rectifying the energy received by the secondary winding; and
a filter connected between the rectifier and the load for filtering energy outputted by the rectifier, thereby outputting the low DC voltage to the load.

10. The high-voltage battery converter according to claim 9 wherein the second-order DC-DC converter includes:
a second feedback circuit connected to an output end of the second-order DC-DC converter for outputting a second feedback signal according to a magnitude of the low DC voltage; and
a second pulse-width modulation control unit connected to a control terminal of the switch circuit and the second feedback circuit for controlling the switching operations of the switch circuit and regulating a duty cycle of the switch circuit according to the second feedback signal, thereby maintaining the low DC voltage at a rated level.

11. The high-voltage battery converter according to claim 10 wherein the rectifier includes a plurality of synchronous rectifiers connected to the second pulse-width modulation control unit for carrying out synchronous rectification by control of the second pulse-width modulation control unit.

12. The high-voltage battery converter according to claim 10 wherein the second pulse-width modulation control unit is connected to a micro-controller unit for reporting an operating status of the second-order DC-DC converter to the micro-controller unit, thereby allowing the micro-controller unit to send information of the operating status of the second-order DC-DC converter to a trip computer of the electric vehicle through a controller area bus interface to facilitate the trip computer to understand the operating status of the second-order DC-DC converter for further processing.

13. The high-voltage battery converter according to claim 12 wherein when the second pulse-width modulation control unit is undergoing an over-voltage condition or an over-current condition, the micro-controller unit activates a protection circuit in the electric vehicle and reports the operating status of the second pulse-width modulation control unit to the trip computer.

14. The high-voltage battery converter according to claim 1 wherein the high-voltage battery converter is applicable to the electric vehicle and mounted in the electric vehicle for releasing electric energy when the electric vehicle is running.

15. The high-voltage battery converter according to claim 1 wherein when a voltage level of the high DC voltage is dropped to be below the predetermined voltage level, the first-order DC-DC converter boosts the high DC voltage to the intermediate voltage having the predetermined voltage level.
